(19) United States
(12) Patent Application Publication
(10) Pub. No.: US 2008/0189487 A1
(43) Pub. Date: Aug. 7, 2008

(54) Control of cache transactions

(75) Inventor: Simon John Craske, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/702,666

(22) Filed: Feb. 6, 2007

(51) Int. Cl. G06F 12/08

(52) U.S. Cl. 711/125

(57) ABSTRACT

A cache memory circuit is provided for use in a data processing apparatus. The cache has a memory array and circuitry for receiving both a transaction input signal and a priority input signal. The priority input signal provides priority information with regard to one or more of the cache transactions received in the transaction input signal. A cache controller is provided for servicing the cache transactions. The cache controller is responsive to the priority input signal to control servicing for at least one of the cache transactions in dependence upon the priority information.

### BACKGROUND OF THE INVENTION

1. Field of the Invention

The present invention relates to cache memory. More particularly this invention relates to controlling cache transactions to improve system determinism.

2. Description of the Prior Art

Cache memories are typically implemented in data processing systems in order to reduce the latency associated with retrieving dating from memory. This latency can arise due to external bus transactions taking numerous processing cycles in order to retrieve stored data (i.e. instructions and/or data values) from memory. Storing frequently-used data and/or instructions in cache memory, which is typically fast on-chip memory, can significantly reduce latency associated with retrieval of data from memory. Caches typically store data in a plurality of cache lines such that each cache line comprises a plurality of cache entries. Each cache entry can take numerous bus cycles to fill (e.g. 10 cycles), so retrieving an entire line of cache data can take many processing cycles and it is difficult to predict how long these cache line fills will take to complete.

Although caches improve system performance by increasing the average speed of retrieval of data but this is at the expense of some system determinism since, for example, if a data processing system receives an interrupt when a cache line fill is underway, it is uncertain how rapidly the data processing system will be able to process the interrupt since the time for completion of the cache line fill is non-deterministic.

Numerous techniques are known for tuning cache performance that aim to mitigate the lack of determinism in data processing systems employing cache memory. For example, it is known to use the technique of “critical word first”, whereby a cache line fill takes place into a temporary buffer and a cache requests data such that the bus transaction corresponding to the CPU (Central Processing Unit) transaction that initiated the cache line fill is presented to the bus first. Thus the requested data word is returned to the CPU before the remainder of the line fill is performed.

The level of determinism can also be improved by implementing shorter cache lines having fewer cache entries per line, but since tag information is required to index the data in each cache line, reducing the line length in cache incurs additional expense in terms of the circuit gate count and the amount of Random Access Memory required to implement the cache.

When events such as interrupts are generated on a data processing system, it is generally desirable to service those interrupts rapidly and efficiently regardless of what processing operations the data processing system is performing at the time the interrupt is generated. The lack of determinism of data processing systems employing caches due to the unpredictability of the time taken to fill cache lines via external bus transactions reduces the degree of determinism with which interrupts may be taken on a system implementing a cache.

### SUMMARY OF THE INVENTION

According to a first aspect, the present invention provides a cache comprising:

a cache memory array having a plurality of cache lines for storing cache entries;

circuitry for receiving both a transaction input signal comprising a plurality of cache transactions for servicing by said cache and a priority input signal providing priority information with regard to at least one of said cache transactions;

a cache controller for controlling servicing of said cache transactions;

wherein said cache controller is responsive to said priority input signal to control servicing of at least one of said plurality of cache transactions in dependence upon said priority information.

The invention recognises that the degree of determinism of the cache can be improved by making the cache responsive to a priority input signal providing priority information with regard to at least one of the cache, transactions. By making the cache controller responsive to the priority information such that at least one of the cache transactions is serviced in dependence upon this priority information different processing can be performed for different cache transactions as required. Furthermore, cache transactions can be interrupted or cancelled in dependence upon the priority information. Accordingly, operations performed by the cache more deterministic. For example, in the event of an interrupt, a cache transaction that is currently being serviced can be terminated to enable the interrupt to be serviced more rapidly.

Thus, for a given data processing transaction, the cache can be made aware of the priority of the new transaction relative to any line fill that is currently being performed in cache and this information can in turn be used to determine whether or not to cancel or interrupt the current line fill operation in favour of servicing the new transaction. Furthermore, the type of processing performed by the cache can be adapted in dependence upon the priority information such that, for example, cache eviction can be suppressed for high priority transactions to avoid the delay associated with evicting and subsequently re-filling a cache line with data including the requested data word. The responsiveness of the cache controller to priority information thus provides improved determinism and reduced latency of the cache. This in turn allows for a cycle-count reduction, which potentially enables the data processor to be clocked at a reduced frequency.

It will be appreciated that the priority input signal could be multiplexed with other data, such as the transaction input signal, and supplied via a common input to the cache. However in one embodiment the circuitry for receiving both the transaction input signal and the priority input signal comprises a first input for receiving the transaction input signal and a second input for receiving the priority input signal. This reduces the complexity of the circuitry provided in the cache and enables straight-forward processing of the priority input signal for use by the cache controller.

It will be appreciated that the priority information could comprise a given priority level or value associated with a plurality of cache transactions, but in one embodiment the priority information comprises a priority value for each of the plurality of cache transactions. This facilitates straightforward correlation between a cache transaction and the associated priority information and allows for more flexibility in differently prioritising individual cache transactions.

It will be appreciated that the priority information can be used in a variety of different ways to influence the order or manner of processing cache transactions. However in one embodiment different processing is performed for different cache transactions in dependence upon the priority information. In particular, the cache controller is operable to suppress at least one of a cache load operation and a cache eviction operation in dependence upon the priority information. This improves the degree of determinism of the cache since it allows cache operations that are typically non-deterministic to be suppressed to preferentially improve the determinism of high priority cache transactions.

In one embodiment, for a given one of the plurality of cache transactions, the cache controller performs different servicing when the priority information specifies respective different priority levels for the given one of the plurality of cache transactions. This allows the servicing performed by the cache to be fine-tuned in accordance with the nature of the cache transaction.

In one embodiment the cache controller is operable to preferentially allocate to given ones of the plurality of cache transactions, storage in the cache memory array in dependence upon the priority information. This enables, for example, interrupt handlers to be placed in known fast memory (i.e. cache memory) preferentially thereby improving system performance for critically-timed routines.

It will be appreciated that the priority information could be used by the cache controller such that individual priority values are used by the cache controller to control servicing of the cache transactions. However, in one embodiment, the cache controller is responsive to the priority information such that priority levels associated with individual ones of the plurality of cache transactions are correlated with ranges of priority values and the cache controller controls servicing of the cache transactions in dependence upon the ranges of priority values.

It will be appreciated that cache transactions could be prioritised in a variety of different ways according to the requirements of the application being run by the data processing system or by the requirements of the operating system. However in one embodiment the priority information provides that transactions associated with interrupt operations have a higher priority than transactions associated with user code. This means that system critical operations such as interrupt operations can be performed more efficiently and with reduced latency whilst transactions that are less time-critical can be completed at a later stage as required.

The priority information could be used simply to change the order of scheduling of cache transactions such that higher priority transactions in a queue of cache transactions are performed before lower priority cache transactions, without interrupting servicing of a transaction currently being serviced. However, in one embodiment the cache controller is operable to halt servicing of a cache transaction currently being serviced in order to preferentially service a subsequently received cache transaction having higher priority. This enables cache transactions that are likely to be non-deterministic or those transactions likely to take many processing cycles (such as cache line fill operations) to be halted to enable servicing of a higher priority transaction.

Although the halted cache transactions could be cancelled completely, in one embodiment the cache controller returns to servicing of the halted cache transaction after servicing of the higher priority cache transaction has been performed. In one such embodiment the halted cache transaction comprises a cache line fill operation. Since cache line fill operations typically take multiple processing cycles to complete where more than one external bus transaction is involved, halting of such transactions can improve the cache determinism.

In one such system where servicing the halted cache transaction is completed following servicing of the higher priority cache transaction, each of the plurality of cache lines has a plurality of cache entries and a respective plurality of valid bits. This means that when the cache controller returns to servicing of the halted cache transaction it can determine from the valid bits, at what stage the cache transaction was halted and pick up the transaction from where it left off without unnecessarily repeating processing operations.

In one such embodiment involving returning to servicing of a halted cache transaction and where a plurality of valid bits are provided, the cache line fill operation is a critical-word-first line fill operation.

The valid bits can be used to allow early line fill termination in the event that the higher priority transaction is issued and provides the further option to allow a return to the cache line to complete the line fill based upon the plurality of valid bits.

This is implemented in one embodiment by halting the current cache transaction once a critical cache entry has been loaded in the cache line of the cache memory array, but halting the transaction before completion of the line fill operation such that only a subset of the plurality of valid bits indicate valid cache entries.

In some embodiments of this type the cache controller controls continuation of the halted cache line fill operation such that only cache entries corresponding to valid bits indicating non-valid cache entries are loaded into the cache memory array. This avoids duplication of retrieval of cache entries associated with the halted cache line fills and thus improves the efficiency of the data processing by reducing the cycle count.

Although continuation of the halted cache line could be performed at any point subsequent to the halting of that transaction, in one embodiment the cache controller controls completion of the halted cache line fill after completion of the higher priority cache transaction.

In an alternative embodiment, completion of the halted cache line fill is performed when the cache controller encounters a subsequent cache hit on the cache line associated with the halted cache line fill. This is an efficient point at which to trigger completion of the halted cache line fill since it is performed at a point at which the data is actually required.

In one embodiment, in the event of a given one of the plurality of cache transactions resulting in a cache hit the cache controller is adapted to process, in dependence upon the priority information, the given cache transaction as if a cache miss had occurred to determine a number of processing cycles associated with a cache miss. Modelling the data access time in this way allows for improved execution determinism, which can be implemented for higher priority transactions.

According to a second aspect the present invention provides a data processing apparatus comprising a priority signal generator for generating a priority signal providing priority information with regard to at least one cache transaction and for supplying said priority information to the cache.

Generating a priority signal for use by a cache allows for the relative priorities of cache transactions to be taken account of by the cache in processing of those transactions and in turn provides improved determinism and improved efficiency of the cache.

According to a third aspect the present invention provides a data processing apparatus comprising:

a cache having:

a cache memory array having a plurality of cache lines for storing cache entries;

a transaction input for receiving a plurality of cache transactions for servicing by said cache;

a priority signal input for receiving a priority signal providing priority information with regard to at least one of said cache transactions;

a cache controller for controlling servicing of said cache transactions;

wherein said cache controller controls servicing of at least one of said plurality of cache transactions in dependence upon said priority information; and

a priority signal generator, for generating said priority signal and supplying said priority signal to said priority signal input of said cache.

According to a fourth aspect the present invention provides a data processing method comprising the steps of:

receiving at a cache a plurality of cache transactions for servicing by said cache;

receiving at a cache a priority signal providing priority information with regard to at least one of said cache transactions;

controlling servicing of at least one of said plurality of cache transactions in dependence upon said priority information.

According to a fifth aspect the present invention provides a cache memory comprising:

a memory array comprising a plurality of cache lines each having a plurality data storage locations;

a valid data memory adapted to store valid data representing whether or not data stored in said memory array is valid;

wherein said valid data represents validity of data corresponding to portions of said cache lines.

Providing valid data that represents the validity of portions of cache lines rather than complete cache lines enables the cache controller to separately identify a plurality of cache entries of a cache line as valid or invalid. This provides more flexibility than having valid data representing the validity of entire cache lines. In particular, cache line fills can be initiated for subsets of data within the cache line enabling subsets of cache line data to be individually accessed. This provides capabilities similar to critical-word first cache implementations but involves less complex cache circuitry.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing apparatus having a cache that is responsive to a priority input signal providing priority information with regard to cache transactions;

FIG. 2 schematically illustrates a program flow for the apparatus of FIG. 1 in the event of an interrupt having been generated and in view of the relative priorities of transactions currently awaiting servicing;

FIG. 3A schematically illustrates a first example cache line structure;

FIG. 3B schematically illustrates an alternative cache line structure comprising a plurality of valid bits and a plurality of dirty bits per cache line;

FIG. 4 is a flow chart that schematically illustrates interruption of a current cache transaction by a subsequently received higher priority cache transaction;

FIG. 5 schematically illustrates a set of signals communicated between the data processor and the cache of FIG. 1 including a priority input signal;

FIG. 6 schematically illustrates circuitry within the cache used to process the priority information;

FIG. 7 is a flow chart that schematically illustrates how different servicing is performed by the cache for a given cache transaction in dependence upon the priority information associated with the cache transaction.

### DESCRIPTION OF THE PREFERRED EMBODIMENTS

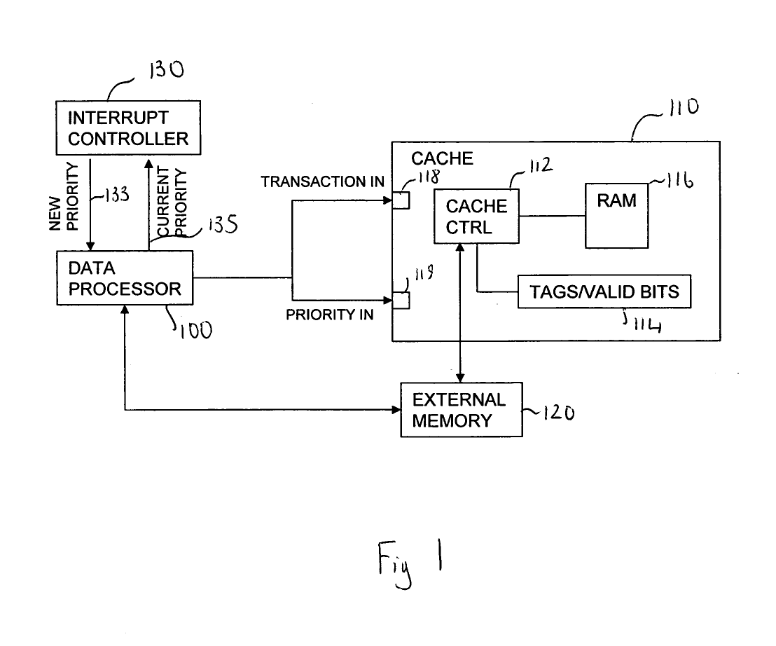

FIG. 1 schematically illustrates the data processing system comprising a cache that is responsive to a priority input signal. The data processing system comprises: a data processor 100; a cache 110 comprising a cache controller 112; a cache tag repository 114; a cache memory array 116; a transaction input port 118; a priority input port 119; an external memory 120; and an interrupt controller 130.

The cache controller 112 receives a plurality of cache translations for servicing via the translation input 118. The cache controller controls servicing of received cache transactions and makes use of the tag repository 114 to determine whether or not data requested by the data processor 100 is currently stored within the cache memory 116.

The cache transactions are associated with instructions being executed by the data processor 100. If the cache controller finds an entry in the cache memory 116 with a tag matching the address of the data item requested by the data processor 100 then this corresponds to a cache “hit”. However, if the data item requested by the data processor 100 does not match any of the cache tags in the tag repository 114 a cache “miss” occurs. In the event of a cache miss, the cache controller 112 initiates a cache line fill operation in order to retrieve the required data from the external memory 120. Subsequent requests for that data will be serviced more quickly for as long as the data remains in the cache 110. However, in the event that the cache 110 is full when a cache miss occurs, data will first be evicted from the cache 110 prior to the cache line fill operation. Replacements of cache lines are made in accordance with a replacement policy.

Each cache line of the cache memory 116 comprises a plurality of cache entries (i.e. individually accessible storage locations). During the course of a cache line fill operation, retrieval of each cache entry from the external memory 120 could take, for example, ten clock cycles of the data processor 100. Thus a cache line fill for a cache line comprising four cache entries could take forty, cycles to complete. This can be contrasted with a latency of, say, one clock cycle for retrieval of a data item associated with a cache hit or a few clock cycles for retrieval from on-chip memory (not shown) within the data processor 100. Accordingly, it will be appreciated that cache line fill operations have considerable latency associated with them.

If the cache controller 112 were restricted to servicing the cache transactions received via the transaction input 118 in order of, receipt, it would mean that if the interrupt controller 130 were to generate an interrupt at a point in time when the cache 110 was performing a cache line fill there would be a considerable delay in servicing the interrupt. Indeed, if the cache line fill had only just started when the interrupt was generated, it is possible that that interrupt would not be serviced by the data processor 100 for tens of clock cycles (disregarding the priority information).

However, in the arrangement of FIG. 1, the cache controller is responsive not only to the transaction input signal received via the transaction input 118 but is also responsive to a priority input signal received via the, priority input 119. The priority input signal provides priority information with regard to one or more of the cache transactions to be serviced by the cache controller 112. The cache controller 112 uses this priority information in order to control servicing Of the cache transactions. Note that not all transactions serviced by the data processor 100 will result in corresponding cache transactions for servicing by the cache controller 112, but the data processor 100 is adapted to send priority information to the cache 110, even for processor transactions having no associated cache transactions so that servicing of cache transactions by the cache controller 112 can be changed in dependence upon any data processing transaction.

The priority information received via the priority input 119 enables the cache controller 112 to perform out-of-order serving of received cache transactions and/or to interrupt current cache transactions in dependence upon the priority information. Furthermore, the cache controller 112 is adapted to be able to perform different types of processing of cache transactions in dependence upon the priority information.

The data processor 100 communicates with the interrupt controller 130 such that when the interrupt controller 130 generates a new interrupt transaction, it sends a signal 133 to the data processor 100 indicating the priority associated with that interrupt transaction. The data processor 100 supplies a signal 135 to the interrupt controller 130 indicating the priority of the transaction currently being executed (which may have associated cache transactions). Thus the interrupt controller 130 can appropriately assign a priority value to the newly generated interrupt instruction. In the event that a transaction currently being serviced by the cache is determined to be of lower priority than a newly issued transaction, then the current cache transaction is cancelled (or interrupted) prior to completion so that the interrupt instruction can be processed in a timely and more deterministic manner. The cancelled cache transaction is rescheduled such that it is either: (i) performed later from the outset as if servicing of the transaction had never been started; or (ii) completed at a later time without repeating servicing operations already performed prior to cancellation of the transaction.

In the arrangement of FIG. 1, the priority input 119 is provided separately from the transaction input 118. However in alternative arrangements a single input is provided for both the transaction input signal and the priority input signal and the cache controller receives the priority information multiplexed with the transaction data. In the embodiment of FIG. 1, the cache 110 is a data cache, but in alternative embodiments, the cache 110 is an instruction cache.

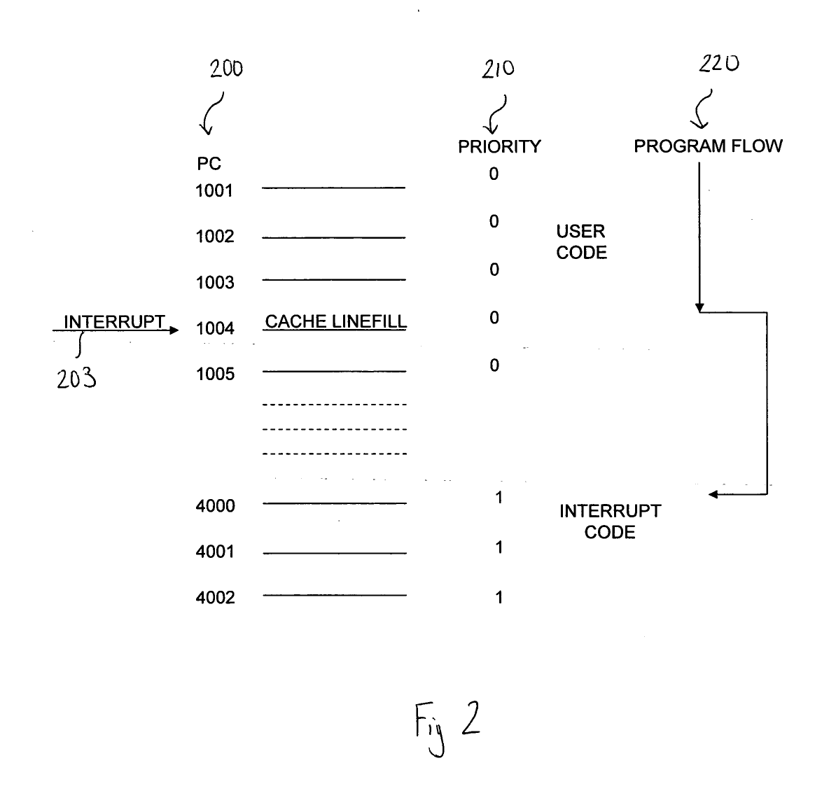

FIG. 2 schematically illustrates an example program flow for a processing sequence performed by the data processing apparatus of FIG. 1. In FIG. 2, a first column 200 lists a sequence of program counter values, which index instructions being executed by the data processor 100 of FIG. 1. The column 210 shows associated priority information for each of the executed program instructions (i.e. transactions) and column 220 illustrates program flow that occurs during the execution sequence.

The instructions corresponding to program counter values 1001 through 1005 are all associated with user code associated with, for example, a program application being executed by the user. The instruction at program counter value of 1004 corresponds to a cache line fill operation. It can be seen from column 210 that each of the instructions corresponding to program counter values 1001-1005 have an associated priority value of zero.

When the instruction corresponding to program counter 1004 is being executed by the data processor 100 (see FIG. 1), an interrupt signal 203 is generated by the interrupt controller 130 of FIG. 1. Since the cache line fill operation associated with program counter value 1004 is likely to take many processing cycles to complete, the cache controller 112 of FIG. 1 interrupts the processing of the cache line fill transaction such that a data processor 100 can proceed with processing of the interrupt signal. Thus the data processor 100 jumps from executing the user code instruction at program counter value 1004 to executing program code associated with the interrupt signal at program counter value 4000.

The instructions at program counter values 4000, 4001 and 4002 each have associated priority values of one and, as such, have a higher priority than the user code instructions corresponding to program counter values 1001 through 1005. The priorities of the user code and the interrupt code in the sequence of program instructions shown in FIG. 2 can be set in advance (i.e. predetermined) on the basis that it is desired to reduce the interrupt latency. Thus the interrupt code can routinely be assigned higher priority than the user code. However, it is not known to the data processor 100 in advance when the interrupt controller 130 will in fact generate an interrupt signal that necessitates branching to the interrupt code at program count values 4000-4002.

In the event that an interrupt is in fact generated by the interrupt controller 130 of FIG. 1, the data processor 100 provides priority information to the cache controller via the priority input 119 to indicate that that the cache transaction currently being executed is to be cancelled pending servicing of the interrupt. This allows for prioritisation of any cache transactions associated with the interrupt code and enables more rapid and more deterministic servicing of the interrupts generated by the interrupt controller 130.

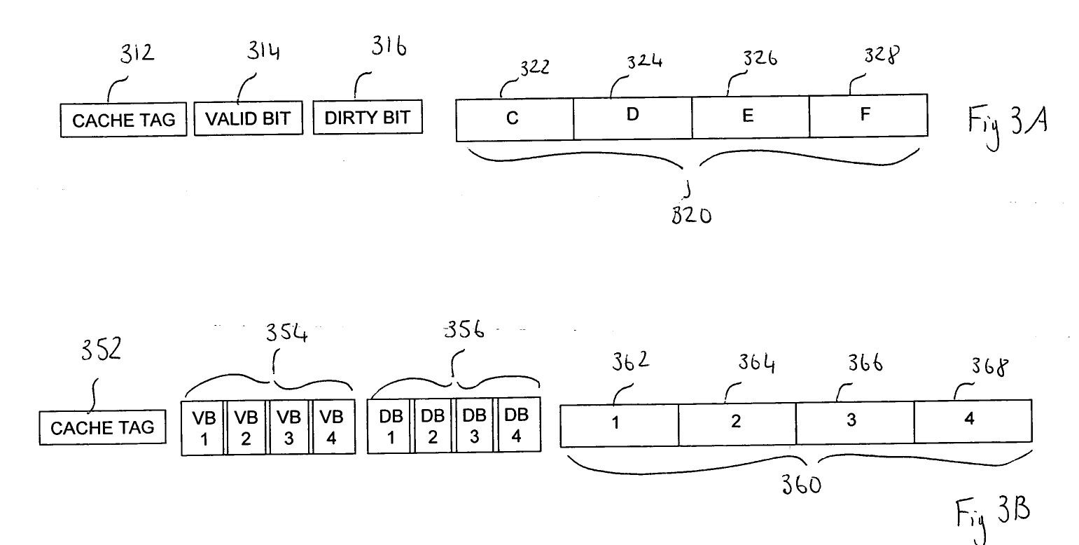

FIGS. 3A and 3B schematically illustrate two alternative cache line structures.

FIG. 3A shows a cache line structure 310 comprising: a cache tag 312; a valid bit 314; a dirty bit 316; and a cache line data 320 comprising four individual cache-line storage locations 322, 324, 326 and 328. Each cache-line storage location is adapted to store an individually accessible cache entry.

The cache tag 312 acts as an identifier to correlate data currently stored in the corresponding cache line with data stored at an address range in the external memory 120 of FIG. 1. The valid bit 314 indicates whether or not the plurality of cache entries in storage locations 322, 324, 326 and 328 are valid data. The dirty bit 316 provides an indication of whether the cache line data 320 has been modified in cache but not yet written back to the external memory 120. If the write back has not yet been performed then the cache line is not yet suitable for eviction. Note that the dirty bit 316 is likely to be present in a data cache but is not likely to be present in an instruction cache.

FIG. 3B shows an alternative cache line structure 350 to that of FIG. 3A. This cache line structure comprises: a cache tag 332; a valid word 354 comprising set of four valid bits; a dirty word 356 comprising a set of four dirty bits; and cache-line data 360 comprising four individual cache-line storage locations.

The difference between the cache line format of FIG. 3A and the cache line format of FIG. 3B is that in FIG. 3B there are multiple valid bits and multiple dirty bits per cache line. In particular the valid word 354 comprises four valid bits corresponding respectively to the four cache storage locations 360. Thus the valid data represents the validity of portions of the cache line. Similarly, the dirty word comprises four dirty bits corresponding respectively to the four cache storage locations 360.

Providing a plurality of valid bits 354 and a plurality of dirty bits 356 per cache line means that extra gates are required in each cache line relative to the line format of FIG. 3A. However, the cache line format of FIG. 3B is more efficient than implementing shorter cache lines (having fewer than four cache-line data storage locations) because a single cache tag 532 is used to index all four cache entries per line. Furthermore the provision of a valid bit for each cache-line data storage location means that processing operations need not be unnecessarily repeated in the event that a cache line fill has been partially completed so that only a subset of the cache entries of the cache line are valid. The valid words facilitate partial cache line fills and enable individually accessible data storage locations to be independently validated. The valid words and dirty words also allow the data processor to determine whether individual cache entries are suitable for eviction from cache. Although in this embodiment a single valid bit is provided for each cache storage location in a cache line it will be appreciated that in alternative embodiments a single valid bit or group of valid bits could be used to represent the validity of different portions of the cache line data e.g. one valid bit for two of the four cache entries.

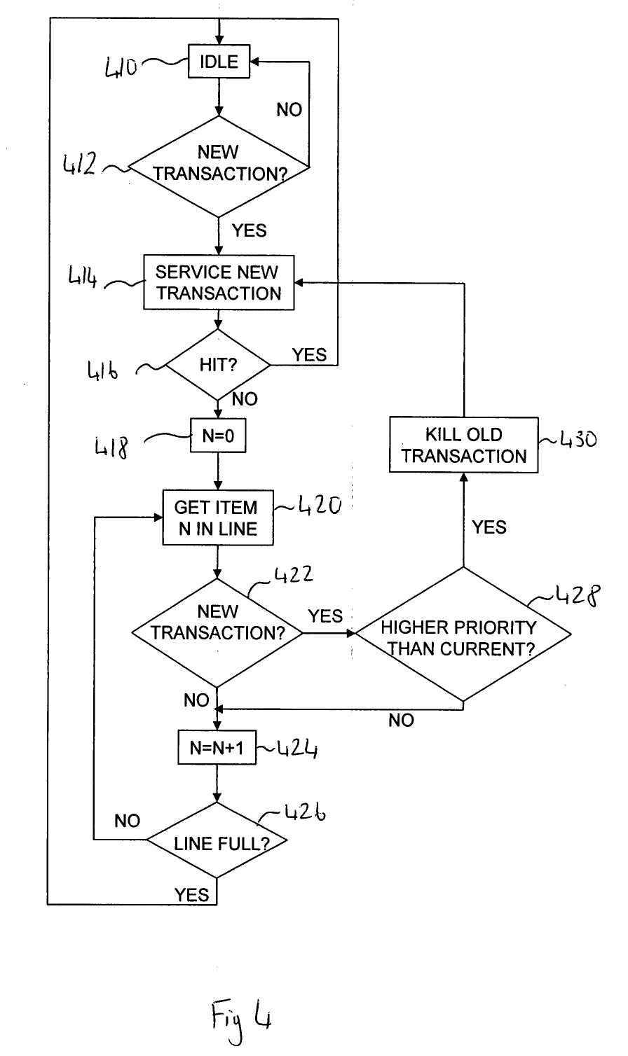

FIG. 4 is a flow chart that schematically illustrates how the cache 110 of FIG. 1 controls servicing of cache transactions in dependence upon the priority information.

The processing begins at stage 410 where the cache 110 is idle. At stage 412 it is determined whether or not a new transaction has been received via the cache transaction input 118 (see FIG. 1). If no new transaction is received then the cache remains idle and the process returns to stage 410. However, if at stage 412 a new transaction has in fact been received then the process proceeds to stage 414 whereupon the new transaction is serviced by the cache controller. Servicing of the cache transaction involves determining whether a cache hit or a cache miss has occurred. In the event of a cache miss a cache line fill is performed (a cache eviction operation is also performed prior to the line fill if the cache is full to capacity).

Servicing the cache transaction involves proceeding to stage 416 where it is determined whether or not the data (or instruction) being requested by the data processor is currently stored within the cache memory 116. If it is determined that there has been a cache hit then the cache reads the requested value from the cache memory and supplies it to the data processing and then returns to the idle stage 410. If, on the other hand, at stage 416 it is determined that there is no cache hit but instead a cache miss has occurred, the process proceeds to stage 418 where a count value N is set to zero. Next at stage 420 a first cache entry is read into the associated cache line. For example for the cache line structure of FIG. 3A there are four cache-line data storage locations and four corresponding cache entries so the index N in this case has the possible values zero, one, two and three.

At stage 420 a critical-word first system is implemented such that the particular one of the four cache entries actually requested by the data processor is read into the cache as a matter of priority and only once the so-called “critical” word has been retrieved are the remaining cache entries of the line retrieved. For example if the data processor has requested data stored in cache-line storage location 366 of FIG. 3B, the cache entry for this data storage location 366 will first be read from external memory followed by cache entries for storage in locations 362, 364 and 368. Thus in this case N=0 corresponds to storage location 366, N=1 corresponds to location 362, N=2 corresponds to location 364 and N=3 corresponds to location 368.

Once the first cache entry has been retrieved at stage 420 the process proceeds to stage 422 whereupon it is determined whether or not a new transaction has been received by the cache during reading in of the critical word. If no new cache transaction has been received at stage 422 and no priority information has been received with regard to a higher priority non-cache transaction (e.g. an interrupt), then the process proceeds to stage 424 whereupon the index N is incremented. After the index N has been incremented it is determined at stage 246 whether or not the cache line is full i.e. whether or not all four cache entries of the cache line fill have been loaded into the cache line. If the cache line is in fact determined to be full from the value of the index then the process proceeds to the idle state 410. If on the other hand, it is determined at stage 246 that the cache line is not yet full, then the processor turns to stage 420 whereupon the next of the cache entries is loaded into the cache. This will be one of the remaining three cache entries other than the critical word that has already been loaded in.

For as long as no new cache transactions are received and no information is received with regard to a higher priority non-cache transaction, the system continues to increment the index N and to load the remaining cache entries until the cache line is full. However, if it is determined at stage 422 that a new transaction has been issued by the data processor whilst the most recent cache entry was being loaded into the cache line then the process proceeds to stage 428 whereupon it is determined whether or not the most recently received transaction (received via the transaction input 118) has a higher priority than the transaction that is currently being serviced or if a higher priority non-cache transaction is awaiting execution by the processor. If the newly received transaction has the same or a lower priority than the transaction currently being processed then the process proceeds to stage 424 and the process of servicing the current transaction continues. However, if the newly received transaction has a higher priority than that currently being serviced then the process proceeds to stage 430 whereupon the current transaction is cancelled or interrupted and the process switches to servicing the new transaction at stage 414.

In arrangements that use the cache line structure of FIG. 3B during the process of performing the loop of stages 418, 420, 424 and 426, each time a new cache entry is successfully written into the cache line then the individual valid bit (corresponding to that cache entry) of the valid word 354 is set to indicate that the individual cache entry contains valid data. Thus the valid word 354 can be used in the event that a partially serviced transaction has been cancelled at stage 430 since the cache can at a later point resume the cancelled cache transaction and load only the subset of cache entries of the cache line that have not already been loaded i.e. the cache effectively continues servicing the cache transaction from the point at which it was interrupted.

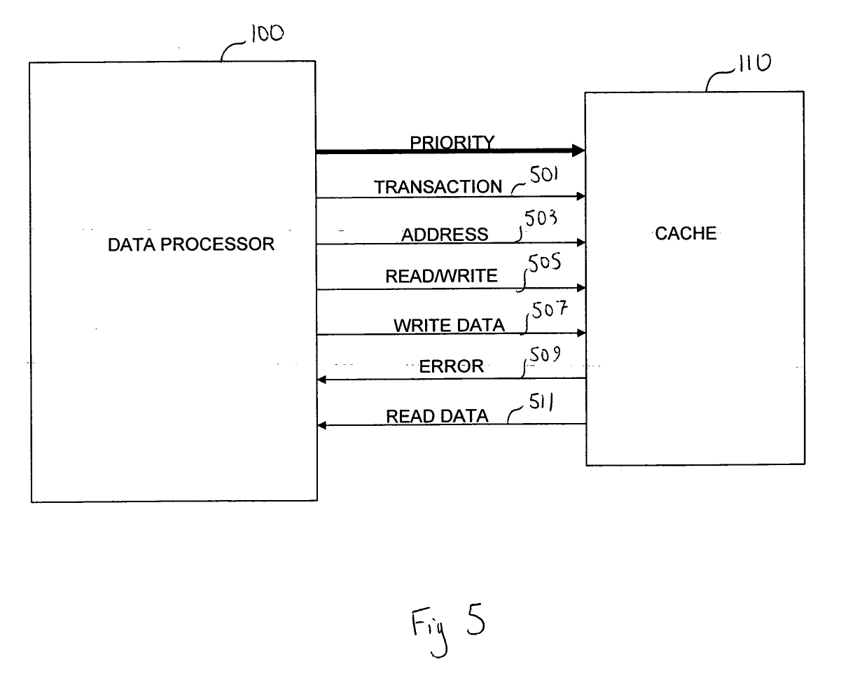

FIG. 5 schematically illustrates a set of control and data signals communicated between the data processor 100 and the cache 110 of FIG. 1. These signals are communicated between the data processor 100 and the cache 100 via one or more data buses. In this particular arrangement, a separate integrated circuit pin is provided for communication of each of the illustrated signals. However in alternative arrangements, two or more of the signals can be multiplexed for communication across a single channel. The signals output by the data processor and received by the cache comprise: a transaction signal 501 specifying transactions to be serviced by the cache 110; an address signal 503 specifying a memory address corresponding to data that the data processor wishes to access (for comparison with the cache tag); a read/write signal 505 indicating whether a data processor wishes to perform a cache read or to write data to the cache; and a write data signal 507 via which data to be stored in the cache during a write transaction is supplied from the data processor to the cache memory.

Two further signals are output by the cache 110 and received by the data processor 100 and these are an error signal 509, which indicates to the data processor an error in the operation of the cache 110 and a read data signal 511 via which data associated with a cache hit is supplied from the cache to the data processor for use by the data processor in executing program instructions.

In FIG. 5 a further additional signal is provided between the data processor and the cache. This is a priority signal 515, which provides priority information with regard to at least one of the processing transactions (cache transactions or otherwise) communicated on the transaction signal 501. The cache 110 uses the priority information in this priority signal to control processing of cache transactions and to modify the sequence and/or manner of processing of cache transactions in dependence upon the priority information. In some embodiments, the priority signal 515 is generated by the data processor alone, but in other embodiments the priority signal 515 is generated by the data processor in cooperation with the interrupt controller 130.

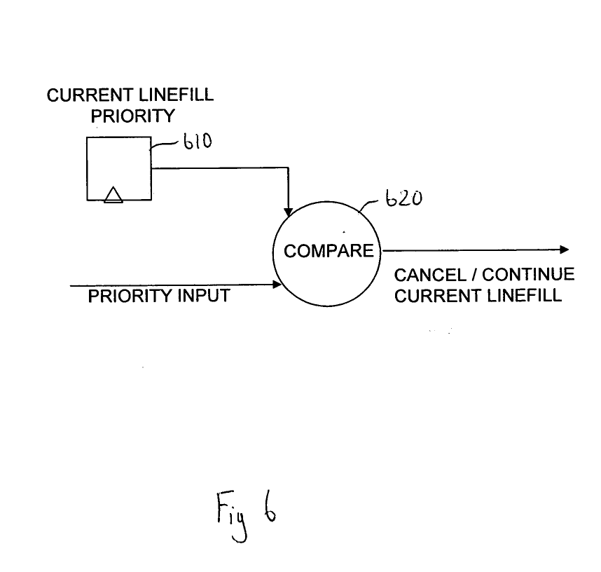

FIG. 6 schematically illustrates circuitry within the cache 110 used for processing the priority information received via the priority input 119 of FIG. 1. The circuitry comprises both a register 610 and compare circuitry 620. The register 610 is operable to store a priority associated with a current cache transaction such as a line fill operation received via the priority input 119. In the event of a further cache transaction being received (with corresponding priority information) or in the event of a higher priority non-cache transaction having been issued, then new priority information is supplied to the compare circuitry 620. The old priority value stored in the register 610 is supplied to the compare circuitry 620 for comparison with the most recently received priority value. The compare circuit compares the stored priority value with the new priority value and in dependence upon the comparison outputs control signals to the cache controller 112 of FIG. 1 to either cancel or proceed with the cache transaction currently being serviced.

In particular, if the priority of the most recently received priority information indicates that a new cache transaction has a higher priority than the current cache transaction that is currently being serviced (and partially complete) then the current cache transaction currently is cancelled. If on the other hand the transaction currently being serviced has a higher priority relative to the most recent priority input then servicing of the current cache transaction will continue to completion.

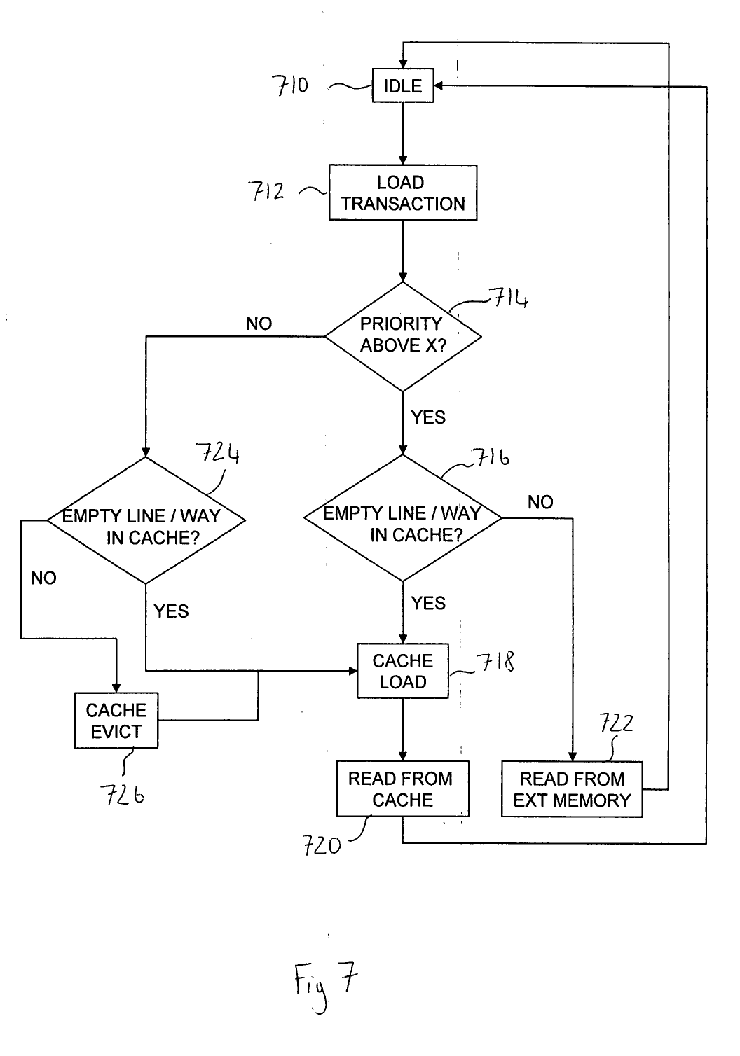

FIG. 7 is a flow chart that schematically illustrates servicing of transactions by the cache of FIG. 1 in response to the priority information such that cache eviction is avoided for high priority transactions. This is one example of a different type of processing being performed for a given cache transaction in dependence upon the priority information.

The process begins at stage 710 where the cache is idle and proceeds to stage 712 when a transaction is loaded by the cache controller (after issue by the data processor).

If the transaction loaded at stage 712 results in a cache miss then the processing proceeds to stage 714.

At stage 714 the cache correlates received priority information from the priority input 119 with the cache transaction associated with the cache miss and determines whether the priority is above a predetermined threshold value X. If indeed the priority of the most recently loaded transaction is above the threshold value then the process proceeds to stage 716, whereupon it is determined by the cache controller whether an empty cache line or cache way (for a set-associative cache) is available in the cache memory. If free space is in fact available in the cache then the process proceeds to stage 718 whereupon a cache load is performed and then proceeds further to stage 720 where the newly loaded data is read from the cache for supply to the data processor. Once data has been read from the cache the transaction is complete and the cache returns to the idle state 710 awaiting servicing of the next cache transaction.

If at stage 714 it is instead determined that the priority of the most recently loaded transaction associated with the cache miss is below the predetermined threshold value X then the process proceeds to stage 724 where it is determined whether or not an empty cache line or cache way is available. In this case, if space is available in cache then the process proceeds to load the desired information into the cache at stage 718 and then to read that loaded information from cache at stage 720 before returning to the idle stage 710.

If on the other hand it is determined that there is no available space in cache at stage 724, then a cache eviction is performed at stage 726 and the process subsequently proceeds to load the required data into the evicted cache line at stage 718 and to read that data from cache at stage 720 before returning to the idle state 710.

However, if at stage 716 it is determined that there is no space available in cache for a cache transaction having a priority above the predetermined threshold X, the processing of the transaction performed by the cache is different from the processing for transactions having priorities at or below the threshold value X. In the case of the transaction priority being above the threshold the process proceeds to stage 722 where the required data is read directly from external memory rather than triggering a cache eviction followed by a cache load. After the data has been read from external memory for supply to the data processor, the process returns to the idle stage 710 awaiting processing of the next cache transaction.

Thus it can be seen that the flow chart of FIG. 7 shows that for high priority transactions in the event that a cache miss occurs and in circumstances where there is no space available in cache, the latency (in terms of processing cycle delays) incurred by performing a cache eviction followed by a cache load operation in order to access the requested data are avoided by suppressing the cache eviction and retrieving the data directly from external memory. Thus the path involving stages 716 and 722 in the flow chart of FIG. 7 provides more deterministic behaviour of the cache by suppressing cache eviction in dependence upon priority information.

If the transaction loaded at stage 712 results in a cache hit then the transaction is serviced by simply reading data from the cache and returning it to the data processor. However, in the event of a cache hit and where the priority of the transaction is above the threshold value, the cache controller performs the memory access that would have been performed had the memory region not been cached (i.e. a cache miss is modelled for the requested data item). Thus the cache controller retrieves the requested data from external memory and monitors and stores the time taken (in terms of processing cycles) to return the requested data to the data processor (which can include the time required to perform a cache eviction). The stored time is then used by the data processing system to maintain execution determinism.

The embodiment of FIG. 7 modifies cache behaviour by suppressing cache eviction in response to the priority information. In an alternative arrangement the priority of a transaction is used to prevent all cache allocation other than for cache transactions associated with the high priority transaction. This can be used to enable an interrupt handler to be stored in fast cache memory and prevent it from being evicted to slower memory.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A cache comprising:
a cache memory array having a plurality of cache lines for storing cache entries;
circuitry for receiving both a transaction input signal comprising a plurality of cache transactions for servicing by said cache and a priority input signal providing priority information with regard to at least one of said cache transactions;
a cache controller for controlling servicing of said cache transactions;
wherein said cache controller is responsive to said priority input signal to control servicing of at least one of said plurality of cache transactions in dependence upon said priority information.

2. A cache according to claim 1, wherein said, priority information comprises a priority value for each of said plurality of cache transactions.

3. A cache according to claim 1, wherein said cache controller is operable to suppress at least one of a cache load operation and a cache eviction operation in dependence upon said priority information.

4. A cache according to claim 1, wherein for a given one of said plurality of cache transactions said cache controller performs different servicing when said priority information specifies respective different priority levels for said given one of said plurality of cache transactions.

5. A cache according to claim 1, wherein said cache controller is operable to preferentially allocate to given ones of said plurality of cache transactions, storage in said cache memory array in dependence upon said priority information

6. A cache according to claim 1, wherein said cache controller is responsive to said priority information such that priority levels associated with said plurality of cache transactions are correlated with ranges of priority values and said cache controller controls servicing of said cache transactions in dependence upon said ranges of priority values.

7. A cache according to claim 1, wherein said priority information provides that transactions associated with interrupt operations have a higher priority than transactions associated with user code.

8. A cache according to claim 1, wherein said cache controller is operable to halt servicing of a cache transaction currently being serviced in order to preferentially service a subsequently received cache transaction having higher priority.

9. A cache according to claim 8, wherein said cache controller returns to servicing of said halted cache transaction after servicing said higher priority cache transaction.

10. A cache according to claim 8, wherein said halted cache transaction comprises a cache line fill operation.

11. A cache according to claim 10, wherein each of said plurality of cache lines has a plurality of cache entries and a respective plurality of valid bits.

12. A cache according to claim 11, wherein said cache line fill operation is a critical-word-first line fill operation.

13. A cache according to claim 12, wherein said current cache transaction is halted once a critical cache entry has been loaded in a cache line of said cache memory array and before completion of said line fill operation such that only a subset of said plurality of valid bits indicate valid cache entries.

14. A cache according to claim 13, wherein when said cache controller controls completion of said halted cache line fill operation such that only cache entries corresponding to valid bits indicating non-valid cache entries are loaded into said cache memory array.

15. A cache according to claim 14, wherein said cache controller controls completion of said halted cache line fill after completion of said higher priority cache transaction.

16. A cache according to claim 14, wherein completion of said halted cache line fill is performed when said cache controller encounters a subsequent cache hit on a cache line associated with said halted cache line fill.

17. A cache according to claim 1, wherein said circuitry comprises a first input for receiving said transaction input signal and a second input for receiving said priority input signal.

18. A cache according to claim 1, wherein in the event of a given one of said cache transactions resulting in a cache hit said cache controller is adapted to process in dependence upon said priority information said given cache transaction as if a cache miss had occurred to determine a number of processing cycles associated with a cache miss.

19. A data processing apparatus comprising a priority signal generator for generating a priority signal providing priority information with regard to at least one cache transaction and for supplying said priority information to a cache.

20. Apparatus according to claim 17, comprising an interrupt controller wherein said interrupt controller is operable to generate at least in part said priority information.

21. A data processing apparatus comprising:
a cache memory array having a plurality of cache lines for storing cache entries;
circuitry for receiving both a transaction input signal comprising a plurality of cache transactions for servicing by said cache and a priority input signal providing priority information with regard to at least one of said cache transactions;
a cache controller for controlling servicing of said cache transactions;
wherein said cache controller is responsive to said priority input signal to control servicing of at least one of said plurality of cache transactions in dependence upon said priority information.; and
a priority signal generator for generating said priority signal and supplying said priority signal to said priority signal input of said cache.

22. Apparatus according to claim 18 comprising an interrupt controller, wherein said interrupt controller is operable provide said priority signal generator with information for generating said priority signal.

23. A data processing method comprising the steps of:
receiving at a cache a plurality of cache transactions for servicing by said cache;
receiving at a cache a priority signal providing priority information with regard to at least one of said cache transactions;
controlling servicing of at least one of said plurality of cache transactions in dependence upon said priority information.

24. A cache memory comprising:
a memory array comprising a plurality of cache lines each having a plurality data storage locations;
a valid data memory adapted to store valid data representing whether or not data stored in said memory array is valid;
wherein said valid data represents validity of data corresponding to portions of said cache lines.
